(19) United States
(12) Patent Application Publication
(10) Pub. No.: US 2014/0247481 A1
(43) Pub. Date: Sep. 4, 2014

(54) OPTICAL COMPONENT FOR THE IR RANGE WITH STRESS-COMPENSATED COATING

(71) Applicant: JENOPTIK Optical Systems GmbH, Jena (DE)

(72) Inventors: Dieter Fasold, Jena (DE); Elvira Gittler, Jena (DE)

(73) Assignee: Jenoptik Optical Systems GmbH, Jena (DE)

(21) Appl. No.: 14/346,057

(22) PCT Filed: Sep. 19, 2012
(86) PCT No.: PCT/DE2012/100289

§ 371 Date: Mar. 20, 2014

(30) Foreign Application Priority Data
Sep. 20, 2011 (DE) 10 2011 053 807.7

(51) Int. Cl. G02B 5/20; G06F 17/50

(52) U.S. Cl. CPC G02B 5/208; G06F 17/5009
USPC 359/359; 703/6

(57) ABSTRACT

A method for designing an optical component for the IR range in which its desired technical characteristics are determined, and the optical component is simulated. The simulated optical component has a layer sequence of layers which are stacked one upon the other and have at least one low-index layer whose refractive index lies in a range from 1.35 to 1.7 and a high-index layer whose refractive index lies in a range from 3 to 5. Subsequently, a modified simulated optical component is generated in that at least one low-index layer of the simulated optical component is divided into at least two partial layers and a mid-index layer is inserted between at least two of the partial layers. The layer thicknesses of the modified simulated optical component are adapted by means of a further simulation such that the modified simulated optical component has the desired technical characteristics.

### RELATED APPLICATIONS

The present application is a U.S. National Stage application of International PCT Application No. PCT/DE2012/100289 filed on Sep. 19, 2012 which claims priority benefit of German Application No. DE 10 2011 053 807.7 filed on Sep. 20, 2011, the contents of each are incorporated by reference in their entirety.

### FIELD OF THE INVENTION

The invention is directed to an optical component for the IR range with strain-compensated coating such as is known generically from DE 101 34 157 A1.

### BACKGROUND OF THE INVENTION

In many applications of optical components, it is increasingly required that these optical components be arranged in an increasingly space-saving manner and that the optical components and the coatings thereof can be produced in an ever more economical manner from few individual components.

Optical components of this type may be used as Fabry-Pérot interferometers. These are basically made up of at least two reflective layers which are spaced apart from one another and separated by an intermediate space referred to as resonant cavity. A controlled variability of the size of the resonant cavity and, therefore, of the optical thickness thereof makes it possible to tune the Fabry-Pérot interferometer.

In U.S. Pat. No. 6,618,199 B2 which is cited by way of example, two mirror structures are provided, and the spacing therebetween defines a resonant cavity of a Fabry-Pérot interferometer. At least one of the mirror structures comprises a movable membrane through which electrostatic forces can act on the mirror structure so that the spacing between the two mirror structures can be adjusted.

EP 1 882 917 A1 describes a tunable dual-band Fabry-Pérot filter which is based on a Fabry-Pérot interferometer and is used in IR metrology and encloses the two atmospheric windows (3 to 5 μm and 8 to 12 μm). The filter basically comprises stacks of layers over a silicon substrate. The layers are alternately low-index (refractive index of 1.2 to 2.5) and high-index (3 to 5.9). Each stack has at least five low-index layers and five high-index layers, respectively. A stack is arranged on a reflector substrate in each instance, these reflector substrates being separated by a resonant cavity whose optical thickness is adjustable, and the Fabry-Pérot filter can be tuned in this way.

The resonant cavity can also be realized by means of one or more optical layers such as is known from U.S. Pat. No. 4,756,602 A. In this case, the optical thickness of the resonant cavity can be selected before the layers are produced but can no longer be varied or even tuned after the filter is made.

The above-mentioned interferometers and filters are often mounted on silicon wafers or germanium wafers using MEMS (microelectromechanical systems) or wafer level packaging technologies. In the case of layers which must be designed to be very thin and in case of thin wafers, the problem arises of designing the coatings so as to be free of strain. Strains must be compensated particularly when requirements respecting the surfaces (planarity) of the optical components and the coatings thereof are very high as has been the case heretofore for applications in the X-ray range and lithography (EUV).

In order to develop dual-band reflectors having predefined and distinct reflectivities with respect to one another in two separated, defined spectral ranges (e.g., mid-wave infrared [MWIR] or LWIR [long-wave infrared]), low-index and high-index dielectric layers are alternately stacked one upon the other in a sequence of layers to build optical components of this type, and the differences in the refractive index selected in the layers must be as large as possible so as to minimize the total thickness of the layer sequence. If there are few layers arranged in a layer sequence, they have correspondingly large individual layer thicknesses.

However, it has been shown in practice that layer sequences with large layer thicknesses, e.g., with layers of germanium and fluorides, are very unstable due to the occurrence of high strains oriented in the same direction, e.g., tensile strains.

Various approaches are known for balancing the compressive or tensile strains proceeding from the layers. For example, layers of materials with opposing strain coefficients can be combined.

In JP 2006-281766 A, for example, two layers are arranged over a substrate, wherein the substrate and first layer have a positive strain coefficient, but the second layer has a negative strain coefficient. This solution is intended to compensate occurring thermal stresses.

For use in the field of EUV lithography, WO 00/19247 likewise discloses the possibility of achieving strain compensation by combining layers having different strain coefficients.

Another method is suggested in DE 101 34 157 A1 which describes combining at least one oxidic optical layer with a layer of aluminum oxide as compensation layer, wherein the aluminum oxide layer is to be applied without ion assist. While the oxidic layers exhibit compressive strains (positive strain coefficients), tensile strains (negative strain coefficient) are present as a result of the aluminum oxide layer. If a plurality of oxidic layers are arranged in a stack, the stack will comprise a six-fold sequence of low-index and high-index layers. The compensation layer can be arranged below, above or between the oxidic layers. The disclosure shows a possibility for flexible compensation of strains in a stack, but does not specify the optical effects exhibited by the at least one compensation layer of aluminum oxide.

Antireflective coatings having only four layers in each instance which are stacked over a substrate are known from U.S. Pat. No. 5,243,458 A. In this case, a layer of zinc sulfide (ZnS) is inserted between layers of materials with tensile strains, e.g., germanium (Ge) or fluorides. The ZnS layer has compressive strains so that the tensile strains in the layer sequence are extensively compensated. Further, the ZnS layer has an adhesion promoting effect between the germanium and the fluorides.

However, the solutions known from the prior art do not eliminate the disadvantageous occurrence of high strains in layers with large layer thicknesses.

### SUMMARY OF THE INVENTION

It is an object of the invention to provide an optical component with a strain-compensated coating and selected technical characteristics for use in the IR range. Likewise, a method is to be provided for the design of an optical component by means of which strain-compensated coatings of the optical component can be designed while adjusting desired technical characteristics simultaneously.

Accordingly a method for designing an optical component for the IR range has the following steps:
a) determining desired technical characteristics of the optical component,
b) simulating an optical component having the desired technical characteristics, wherein the simulated optical component has a layer sequence of layers which are stacked one upon the other and have at least one low-index layer whose refractive index lies in a range from 1.35 to 1.7 and a high-index layer whose refractive index lies in a range from 3 to 5,
c) generating a modified simulated optical component by dividing at least one low-index layer of the simulated optical component into at least two partial layers and by inserting a mid-index layer between at least two of the partial layers, wherein the refractive index of the mid-index layer lies in a range from 1.8 to 2.5 and its strain coefficient has an opposite sign with respect to the strain coefficient of every low-index layer and every high-index layer,
d) adapting the layer thicknesses of the modified simulated optical component by means of a further simulation such that the modified simulated optical component has the desired technical characteristics, and
e) providing the results of the further simulation such that information about the layer sequence and specification of the thicknesses of the layers of the layer sequence are accessible to a user.

The term “design” as used hereinafter refers to the production of the optical component in virtual form. In this respect, the optical component can be present as dataset during implementation of the method according to the invention and can be represented, for example, in tabular form and/or as a schematic graph.

By “desired technical characteristics” is meant broadly all of the characteristics of the optical component relevant for the function thereof. For example, optical characteristics as well as mechanical and/or chemical properties of the optical component can be technical characteristics.

In an exemplary embodiment of the method according to the invention, the desired technical characteristics are provided in that at least two portions are realized by the optical component over a wavelength range from 0.8 to 16 micrometers, along which two portions the optical component has a determined reflectivity in the range from 50 to 100% in each instance. In a particularly preferred manner, each of the portions in the region of one of the two atmospheric windows, as they are called, lies in the range from 3 to 5 μm (MWIR) and in the range from 8 to 12 μm (LWIR), respectively.

Any reflectivity can be selected for the portions. The design of the optical component by means of the method according to the invention allows the reflectivities of the optical component to be adjusted in accordance with the selection made.

Any manual or computer-assisted method for the design of an optical component with desired technical characteristics can be used for the simulation of the simulated optical component. The simulation is carried out by means of a suitable simulation program such as is known in the art. The further simulation is also carried out using a simulation program. In so doing, the at least one inserted mid-index layer in the layer sequence must be taken into account. A simulation and a further simulation preferably include a substrate of the layer sequence in each instance.

An aspect of the method according to the invention resides in devising a layer sequence (stack) of high-index layers and low-index layers by means of which the desired technical characteristics of the optical component are brought about and the layer sequence is subsequently modified such that strains occurring between and within the layers of the layer sequence are reduced. In order to reduce the very detrimental strains between the high-index layers and low-index layers, mid-index layers are inserted into the devised layer sequence (compensation layer). These mid-index layers have also proved advantages inasmuch as a very desirable adhesion promotion is achieved between high-index layers and low-index layers and between the materials used for the high-index layers and low-index layers, respectively, by means of these mid-index layers.

It is an important feature of the invention that at least one low-index layer is divided into partial layers. In this way, undesirably large layer thicknesses are avoided and are divided up over a plurality of partial layers of an originally simulated layer. As a result of this procedure, at least one mid-index layer is arranged directly between low-index partial layers which are made of the same material.

In further embodiments of the method according to the invention it is also possible to divide a layer into at least three partial layers and to insert a further high-index layer or low-index layer between two of the partial layers in addition to a mid-index layer.

Preferably, the mid-index layers (compensation layers) inserted between the partial layers are selected with layer thicknesses between 20 and 150 nm, preferably between 30 and 100 nm. It is advantageous when the layers are divided such that none of the partial layers has a layer thickness of more than 1500 nm, for example.

Further mid-index layers can be inserted into the layer sequence of the optical component. These further mid-index layers need not be inserted between partial layers.

It is further possible that in step c) at least one high-index layer of the simulated optical component is additionally divided into at least two partial layers and a mid-index layer is inserted between at least two of the partial layers.

In further embodiments of the method according to the invention it is possible that only the layer thickness of the mid-index layer or mid-index layers is adapted in the further simulation in step d). The desired technical characteristics are then adjusted while retaining the simulated layer thicknesses of the low-index layers and high-index layers of the simulated optical component and while changing the layer thicknesses of the mid-index layers.

In a further embodiment of the method according to the invention, the low-index layers and high-index layers or only the low-index layers or the high-index layers, respectively, can also be adapted to the modified simulated optical component in addition to the mid-index layers in the further simulation.

The dividing of the low-index layer can take place in a virtual manner by means of individual input, e.g., by an operator of the simulation program. The decisions made about the type (e.g., quantity of partial layers, thickness or ranges of thickness of one or more or all of the partial layers) and location (selection of the layers to be divided in the stack) of the divisions can be inputted as dataset into the simulation program. In further embodiments of the method according to the invention, some or all of the decisions about the type and location of divisions can also be stored already beforehand as datasets, for example, in the form of rules. The division of low-index layers—possibly also of high-index layers—and the insertion of mid-index layers can then also be carried out in an automated manner while taking into account the datasets stored beforehand.

The method according to the invention can be used for producing an optical component. To this end, the optical component is designed in the manner described above and is produced by means of suitable known methods on the basis of the results of the further simulation which are obtained and made available in step e).

An optical component for the IR range may also be provided having a substrate and a stack of optical layers with individual layer thickness which are stacked one upon the other on the substrate. The stack has at least one low-index layer whose refractive index lies in a range from 1.35 to 1.7 and a high-index layer whose refractive index lies in a range from 3 to 5. At least one low-index layer is divided into at least two partial layers. There is present between at least two of the partial layers a mid-index layer whose refractive index lies in a range from 1.8 to 2.5 and whose strain coefficient has an opposite sign with respect to the strain coefficient of every low-index layer and of every high-index layer. A sequence of layers of the stack is selected in such a way that the reflectivity of the coating has selected, mutually independent values in a range from 50 to 100% reflectivity in a wavelength range from 0.8 to 16 μm over at least two portions of this wavelength range.

The terms “stack” and “layer sequence” are used synonymously in the description.

The optical component can have further mid-index layers in addition to the mid-index layer present between the two partial layers. These further mid-index layers can be present between further partial layers, between low-index layers, between high-index layers or between low-index layers and high-index layers.

Preferably, at least two portions having mutually independent reflectivities with values of between 50 and 100% are generated by means of the optical component over the wavelength range from 0.8 to 16 μm. The construction of the optical component is preferably selected such that at least one portion with a reflectivity between 50 and 100% is generated over at least one partial portion of each atmospheric window (3 to 5 μm and 8 to 12 μm).

The at least two portions of the wavelength range can also be referred to as spectral wavelength bands or dual bands.

In certain embodiments of the optical component according to the invention, the layer thicknesses of each of the mid-index layers (compensation layers) which are present in the stack and which are inserted between the partial layers are 20 to 150 nm, preferably 30 to 11 nm. It is further preferable that the mid-index layers make up at least 20%, preferably at least 25%, of the total thickness of the stack. The mid-index layers have strain coefficients with signs opposite to those of the strain coefficients of every low-index layer and every high-index layer.

An advantage of the invention consists in that the reflectivity can be selected through the selection of the layer thickness of at least one of the provided mid-index layers. Accordingly, it is possible to adjust the reflectivity of an optical component to be produced according to the invention in accordance with the requirements resulting from the intended use of the optical component while retaining the quantity, sequence, layer thicknesses and materials of the rest of the layers of the stack such that a given reflectivity of the optical component can be realized. By “adjustment” is meant that a stack can be arranged on a substrate, e.g., through deposition by means of PVD or other known methods, and the adjustment of reflectivity is carried out through the corresponding configuration of the at least one mid-index layer in the course of the arrangement. The optical component according to the invention was preferably designed by means of the method according to the invention.

In further embodiments of the optical component, the sequence, layer thicknesses, quantity and materials of the further layers of the stack present in an optical component can also be selected and adjusted in such a way that the desired optical effects are achieved. In particular, the reflectivity of the optical component to be produced is adjusted corresponding to the requirements resulting from the intended use of the optical component.

In this regard, subject to the presence of the partial layers and the mid-index layer provided therebetween, the adjustability of reflectivity is not bound to a determined embodiment, i.e., to a determined sequence of layers, to the layer thicknesses, to the quantity or to the materials of the layers of the stack of the optical component according to the invention.

In a preferred embodiment of the optical component according to the invention, the strain coefficients of the mid-index layers are positive, i.e., compressive strains are introduced into the stack through the material of the mid-index layers.

The material of the high-index layers is preferably selected separately for each of the high-index layers from a group comprising the elements germanium (Ge), silicon (Si) and the compounds lead telluride (PbTe) and cadmium telluride (CdTe).

An embodiment of the optical component according to the invention in which the material of the mid-index layers is selected separately for each of the mid-index layers from a group comprising the compounds zinc sulfide (ZnS), zinc selenide (ZnSe), silicon oxide (SiO) and chalcogenide is likewise preferred.

Further, the material of the low-index layers is preferably selected separately for each of the low-index layers from a group comprising the compounds ytterbium fluoride (YbF₃), barium fluoride (BaF₂), magnesium fluoride (MgF₂) and calcium fluoride (CaF₂). The material of the low-index layers can also be selected from oxides with refractive indexes in the range from 1.35 to 1.7, for example, SiO.

The material of the substrate is preferably selected from a group comprising the elements Ge, Si and the compounds chalcogenide glasses, ZnS, ZnSe, sapphire, quartz, fused silica, CaF₂ and MgF₂.

Surprisingly, it transpired that in addition to a strain compensation and an adjustability of the reflectivity an improved adhesion promotion, particularly between Ge and YbF₃, is also achieved by means of the at least one mid-index layer through the use of ZnS.

The specific configuration of the optical component according to the invention required for achieving desired technical characteristics such as a determined optical effect, for example, can be carried out by means of a suitable computer-assisted simulation.

The optical component according to the invention can be a MEMS component. It can likewise be used as narrow-band filter or as a single-band, dual-band or multi-band reflector. When used as single-band filter, only one band is used even if the optical component according to the invention has a plurality of bands.

### BRIEF DESCRIPTION OF THE DRAWINGS

Embodiments of the optical component are described more fully in the following with reference to embodiment examples and diagrams. The diagrams show:

FIG. 1 is a schematic diagram of a first embodiment of the optical component according to the invention;

FIG. 2 is the functional relationship between reflectivity and wavelength in the first embodiment;

FIG. 3 is a schematic diagram of a second embodiment of the optical component according to the invention;

FIG. 4 is the functional relationship between reflectivity and wavelength in the second embodiment

FIG. 5 is a schematic diagram of a third embodiment of the optical component according to the invention;

FIG. 6 is the functional relationship between reflectivity and wavelength in the third embodiment;

FIG. 7 is a schematic diagram of a fourth embodiment of the optical component according to the invention;

FIG. 8 is the functional relationship between reflectivity and wavelength in the fourth embodiment;

FIG. 9 is a schematic diagram of a fifth embodiment of the optical component according to the invention;

FIG. 10 is the functional relationship between reflectivity and wavelength in the fifth embodiment;

FIG. 11 is a schematic diagram of a sixth embodiment of the optical component according to the invention;

FIG. 12 is the functional relationship between reflectivity and wavelength in the sixth embodiment;

FIG. 13 is a schematic diagram of a seventh embodiment of the optical component according to the invention; and

FIG. 14 is the functional relationship between reflectivity and wavelength in the seventh embodiment.

### DESCRIPTION OF THE EMBODIMENTS OF THE INVENTION

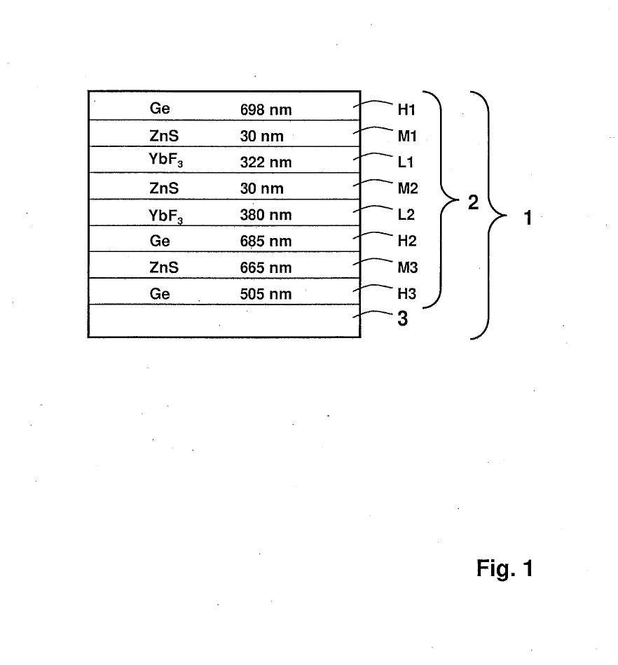

In a first embodiment of the optical component 1 according to the invention shown in FIG. 1, there is stacked on a substrate 3, ZnS (zinc sulfide) in the present instance, a stack 2 of eight layers, of which two layers are low-index layers L1, L2, are made of YbF₃ (yttrium fluoride) and have individual layer thicknesses of 322 nm and 380 nm; three layers are mid-index layers M1 to M3, are made of ZnS (zinc sulfide) and have individual layer thicknesses of 30 nm, 30 nm and 665 nm; three layers are high-index layers H1 to H3, are made of Ge (germanium) and have individual layer thicknesses of 698 nm, 685 nm and 505 nm. The mid-index layer M2 is provided between layers L1 and L2. The sequence of layers of the stack 2 over the substrate 3 is shown in FIG. 1. The mid-index layers M1 to M3 have compressive strains, the low-index layers L1 and L2 and the high-index layers H1 to H3 have tensile strains.

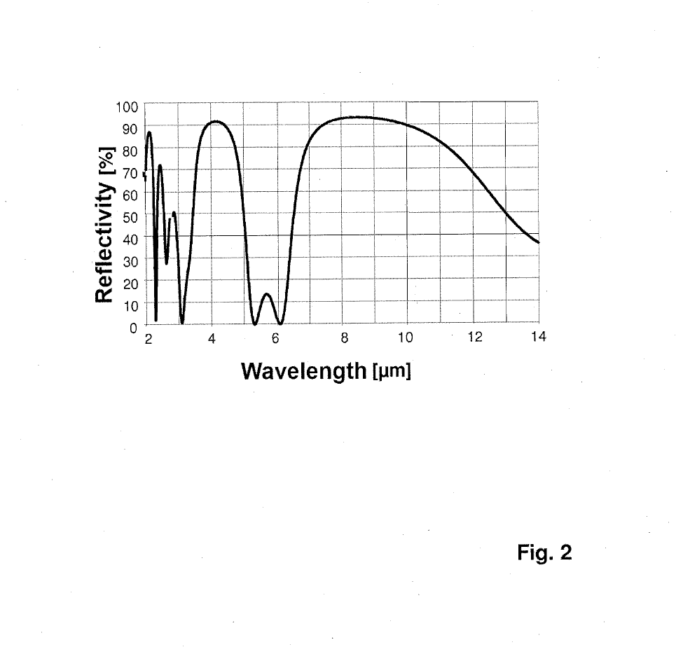

As is shown schematically in FIG. 2, the optical component 1 according to the first embodiment has a reflectivity of more than 50% in a wavelength range of a first atmospheric window (3 to 5 μm) from about 3.3 to 4.8 μm and in a wavelength range of a second atmospheric window (8 to 12 μm) from about 6.4 to 12.75 μm, and there is a reflectivity of greater than 90% in a wavelength range from about 3.75 to 4.25 μm and in a wavelength range from about 7.25 to 9.75. The highest values of reflectivity of 92% are achieved in the wavelength ranges from 3.8-4.2 μm and 7.5-9.3 μm.

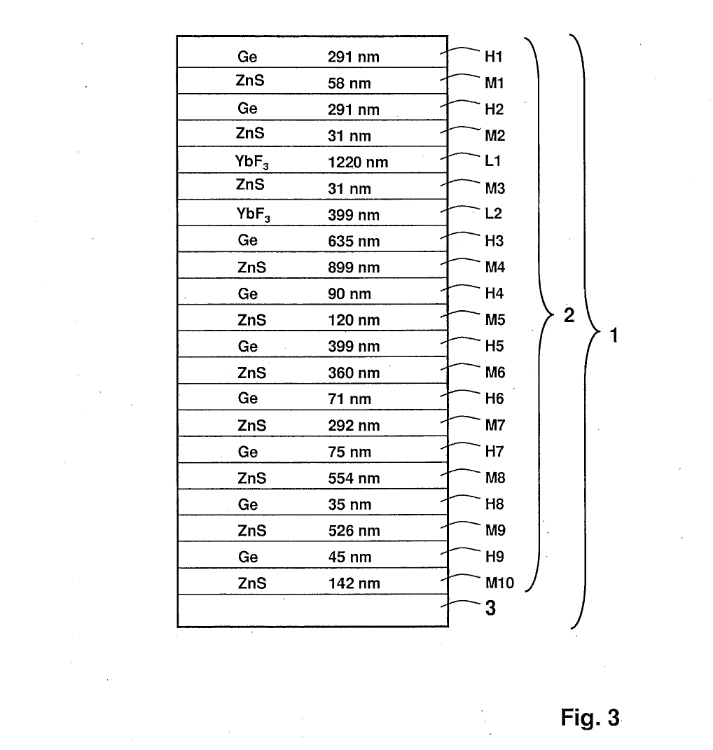

In a second embodiment according to FIG. 3, there is stacked on a substrate 3, Si (silicon) in the present instance, a stack 2 of twenty-one layers, of which two layers are low-index layers L1, L2, are made of YbF₃ and have individual layer thicknesses of 1220 nm and 399 nm; ten layers are mid-index layers M1 to M10, are made of ZnS and have individual layer thicknesses of 31 nm to 899 nm; nine layers are high-index layers H1 to H9, are made of Ge and have individual layer thicknesses of from 35 nm to 635 nm. The mid-index layer M3 is provided between layers L1 and L2. The sequence of layers of the stack 2 over the substrate 3 is shown in FIG. 3. The mid-index layers M1 to M10 have compressive strains, the low-index layers L1 and L2 and the high-index layers H1 to H9 have tensile strains.

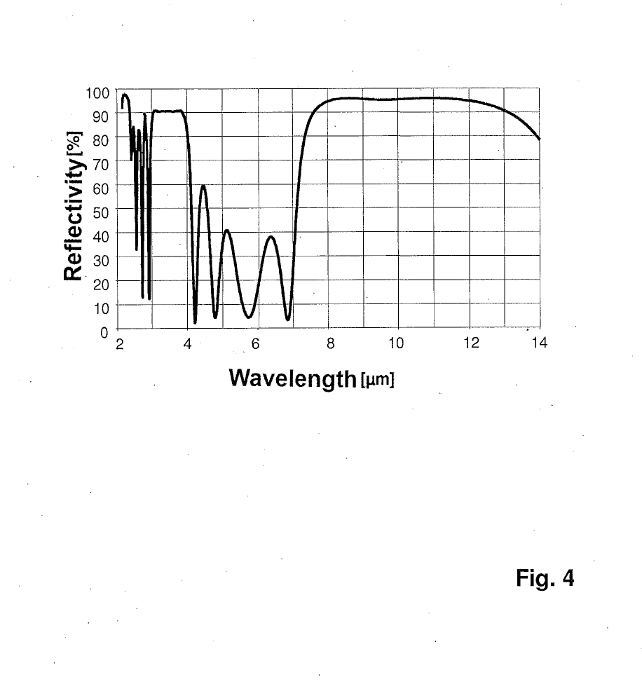

As is shown schematically in FIG. 4, the optical component 1 according to the second embodiment has a reflectivity of greater than 50% in a wavelength range of a first atmospheric window (3 to 5 ρm) from about 3.0 to 4.1 μm and in a wavelength range of a second atmospheric window (8 to 12 μm) from about 7.1 μm to at least 14 μm, and there is a reflectivity of at least 90% in a wavelength range from about 3.0 to 3.8 μm and in a wavelength range from about 7.6 to 13 μm. The highest values of reflectivity are achieved in the wavelength ranges from 3.0-3.8 μm (90%) and 8.0-12.0 μm (94%).

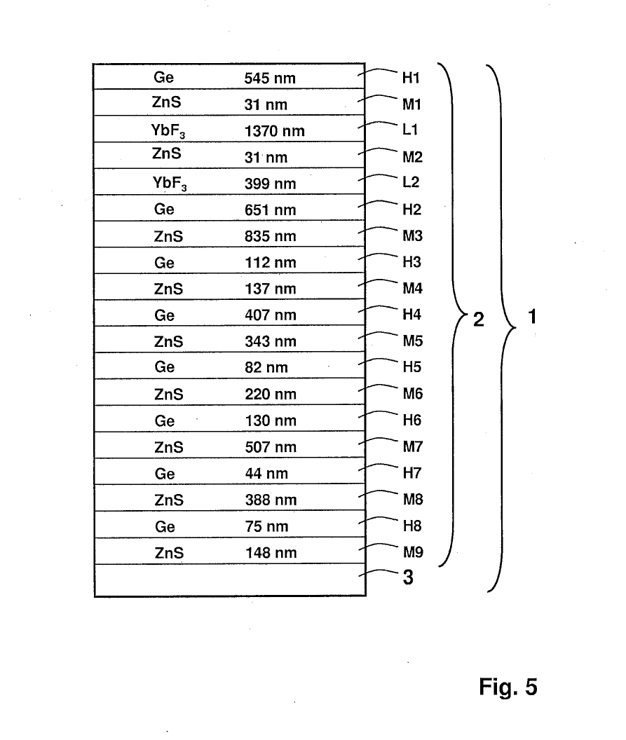

In a third embodiment according to FIG. 5, there is stacked on a substrate 3, CaF₂ (calcium fluoride) in the present instance, a stack 2 of nineteen layers, of which two layers are low-index layers L1, L2, are made of YbF₃ and have individual layer thicknesses of 1370 nm and 399 nm; nine layers are mid-index layers M1 to M9, are made of ZnS and have individual layer thicknesses of 31 nm to 835 nm; eight layers are high-index layers H1 to H8, are made of Ge and have individual layer thicknesses from 44 nm to 651 nm The mid-index layer M2 is provided between layers L1 and L2. The sequence of layers of the stack 2 over the substrate 3 is shown in FIG. 5. The mid-index layers M1 to M9 have compressive strains, the low-index layers L1 and L2 and the high-index layers H1 to H8 have tensile strains.

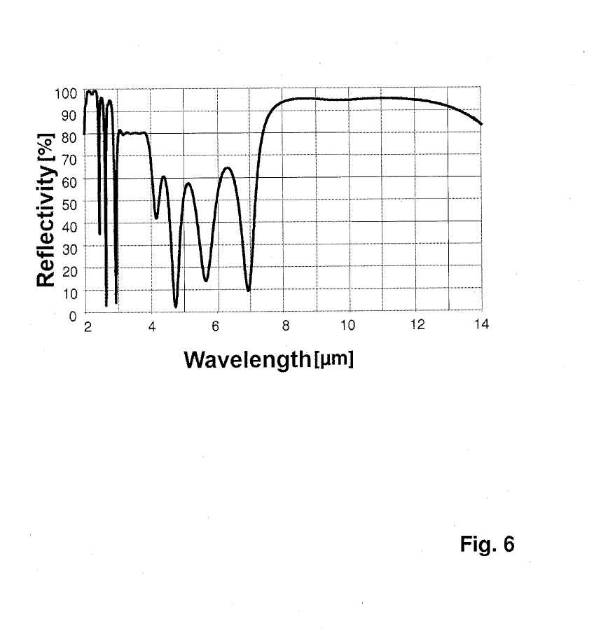

As is shown schematically in FIG. 6, the optical component 1 according to the third embodiment has a reflectivity of greater than 50% in a wavelength range of a first atmospheric window (3 to 5 μm) from about 3.0 to 4.1 μm and in a wavelength range of a second atmospheric window (8 to 12 μm) from about 7.1 μm to at least 14 μm, and there is a reflectivity of at least 80% in a wavelength range from about 3.0 to 3.8 μm and in a wavelength range from about 7.4 to 14 μm. The highest values of reflectivity are achieved in the wavelength ranges from 3.0-3.8 μm (80%) and 8.0-12.0 μm (94%).

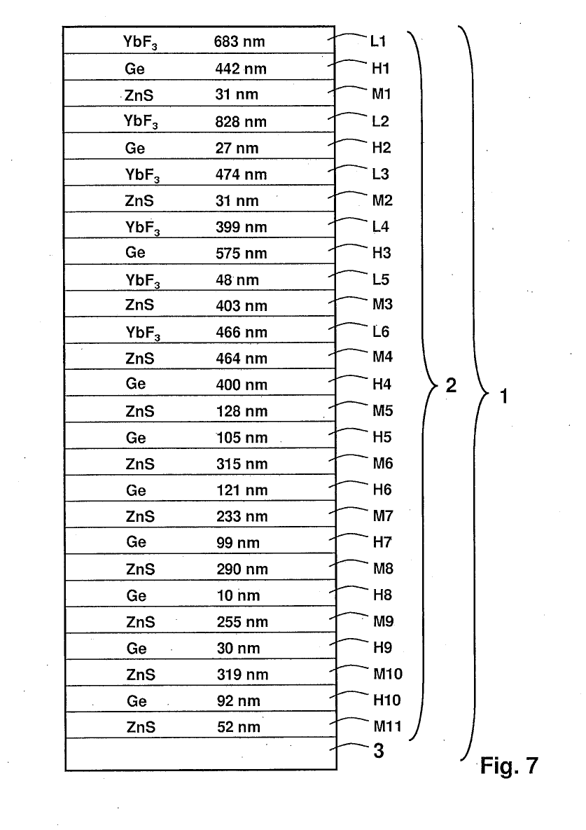

In a fourth embodiment according to FIG. 7, there is stacked on a substrate 3, sapphire in the present instance, a stack 2 of twenty-seven layers, of which six layers are low-index layers L1 to L6, are made of YbF₃ and have individual layer thicknesses of from 48 nm to 828 nm; eleven layers are mid-index layers M1 to M11, are made of ZnS and have individual layer thicknesses of from 31 nm to 464 nm; ten layers are high-index layers H1 to H10, are made of Ge and have individual layer thicknesses of from 10 nm to 575 nm. A mid-index layer M2 and M3, respectively, is provided between layers L3 and L4 and between layers L5 and L6. The sequence of layers of the stack 2 over the substrate 3 is shown in FIG. 7. The mid-index layers M1 to M11 have compressive strains, the low-index layers L1 to L6 and the high-index layers H1 to H10 have tensile strains.

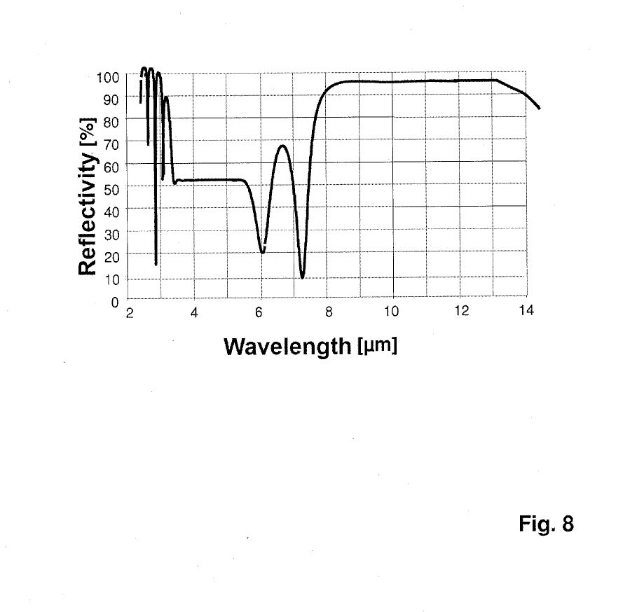

As is shown schematically in FIG. 8, the optical component 1 according to the fourth embodiment has a reflectivity of at least 50% in a wavelength range of a first atmospheric window (3 to 5 μm) from about 3.1 to 5 μm and in a wavelength range of a second atmospheric window (8 to 12 μm) from about 7.1 μm to at least 14 μm, and there is a reflectivity of at least 90% in a wavelength range from about 7.6 to 13 μm. The highest value of reflectivity of 94% is achieved in the wavelength range from 8.0-12.8 μm.

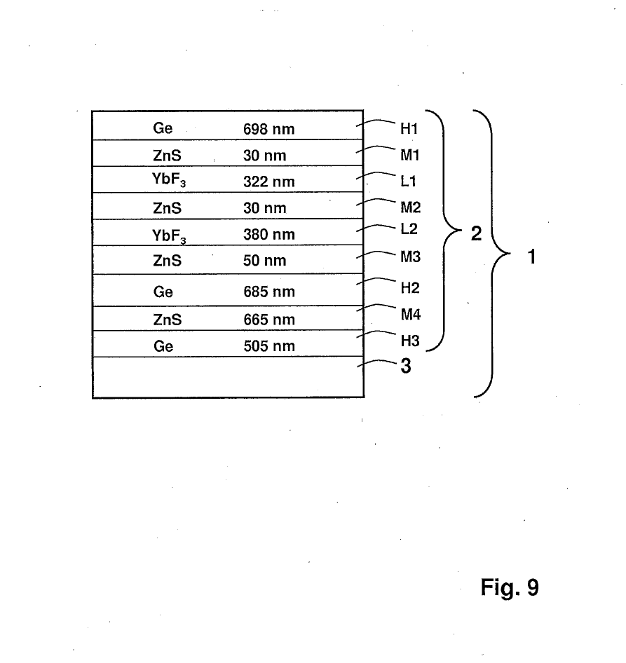

In a fifth embodiment of the optical component 1 according to the invention shown in FIG. 9, there is stacked on a substrate 3, ZnS (zinc sulfide) in the present instance, a stack 2 of nine layers, of which two layers are low-index layers L1, L2, are made of YbF₃ (yttrium fluoride) and have individual layer thicknesses of 322 nm and 380 nm; four layers are mid-index layers M1 to M4, are made of ZnS (zinc sulfide) and have individual layer thicknesses of 30 nm, 30 nm, 50 nm and 665 nm; three layers are high-index layers H1 to H3, are made of Ge (germanium) and have individual layer thicknesses of 698 nm, 685 nm and 505 nm. The mid-index layer M2 is provided between (partial) layers L1 and L2. The sequence of layers of the stack 2 over the substrate 3 is shown in FIG. 9. The mid-index layers M1 to M4 have compressive strains, the low-index layers L1 to L2 and the high-index layers H1 to H3 have tensile strains. The chief effects of the mid-index layers M1 to M4 are indicated in more detail by way of example in this embodiment example. Mid-index layer M2 serves primarily to reduce the strains in the stack, while mid-index layers M1 to M3 serve primarily for adhesion promotion between layers H1 and L1 and between layers L2 and H2. Mid-index layer M4 is primarily an optical layer but also serves to reduce strains between the high-index (partial) layers H2 and H3.

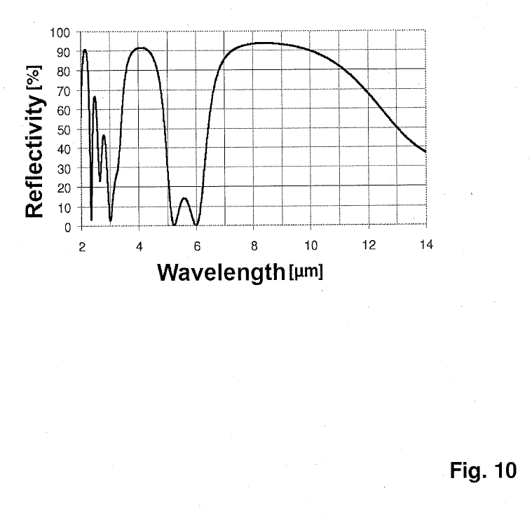

As is shown schematically in FIG. 10, the optical component 1 according to the fifth embodiment has a reflectivity of at least 50% in a wavelength range of a first atmospheric window (3 to 5 μm) from about 3.4 to 4.9 μm and in a wavelength range of a second atmospheric window (8 to 12 μm) from about 6.4 μm to 13 μm, and there is a reflectivity of greater than 90% in a wavelength range from about 3.8 to 4.3 μm and in a wavelength range from about 7.3 to 9.8. The highest values of reflectivity are achieved in the wavelength ranges from 4.1-4.2 μm and 8-9 μm.

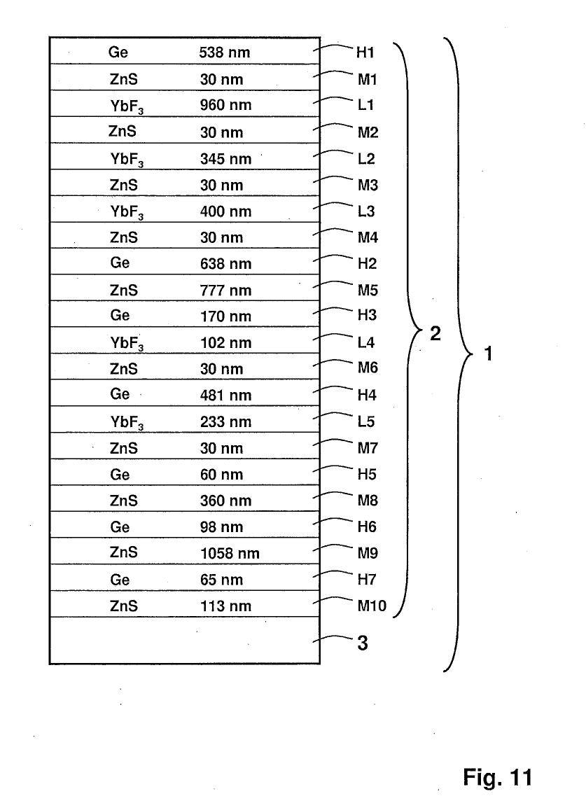

In a sixth embodiment of the optical component 1 according to the invention shown in FIG. 11, there is stacked on a substrate 3, ZnS (zinc sulfide) in the present instance, a stack 2 of twenty-two layers, of which five layers are low-index layers L1 to L5, are made of YbF₃ (yttrium fluoride) and have individual layer thicknesses of 960 nm, 345 nm, 400 nm, 102 nm and 233 nm; ten layers are mid-index layers M1 to M10, are made of ZnS (zinc sulfide) and have individual layer thicknesses of 30 nm, 30 nm, 30 nm, 30 nm, 777 nm, 30 nm, 30 nm, 360 nm, 1058 nm and 113 nm; seven layers are high-index layers H1 to H7, are made of Ge (germanium) and have individual layer thicknesses of 538 nm, 638 nm, 170 nm, 481 nm, 60 nm, 98 nm and 65 nm. A mid-index layer M2 and M3, respectively, is provided between layers L1 and L2 and between layers L2 and L3. The sequence of layers of the stack 2 over the substrate 3 is shown in FIG. 11. The mid-index layers M1 to M10 have compressive strains, the low-index layers L1 to L5 and the high-index layers H1 to H7 have tensile strains.

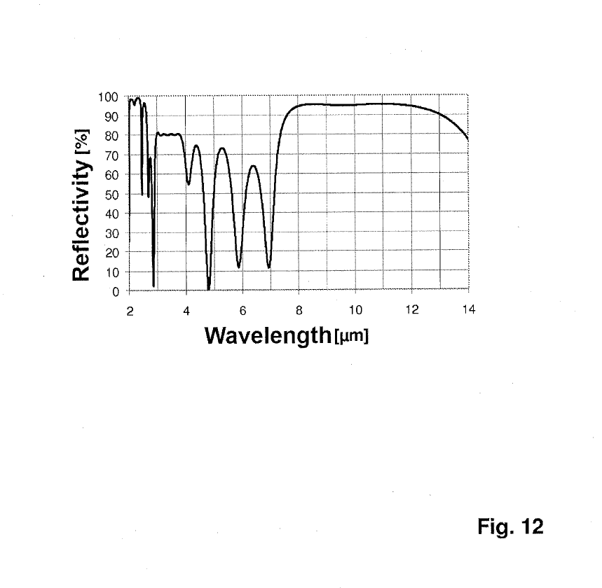

As is shown schematically in FIG. 12, the optical component 1 according to the sixth embodiment has a reflectivity of at least 50% in a wavelength range of a first atmospheric window (3 to 5 μm) from about 3 to 4.6 μm and over a wavelength range of a second atmospheric window (8 to 12 μm), and there is a reflectivity of greater than 90% in a wavelength range from about 7.7 to 13 μm. The highest values of reflectivity are achieved in the wavelength ranges from 8 to 11.5 μm.

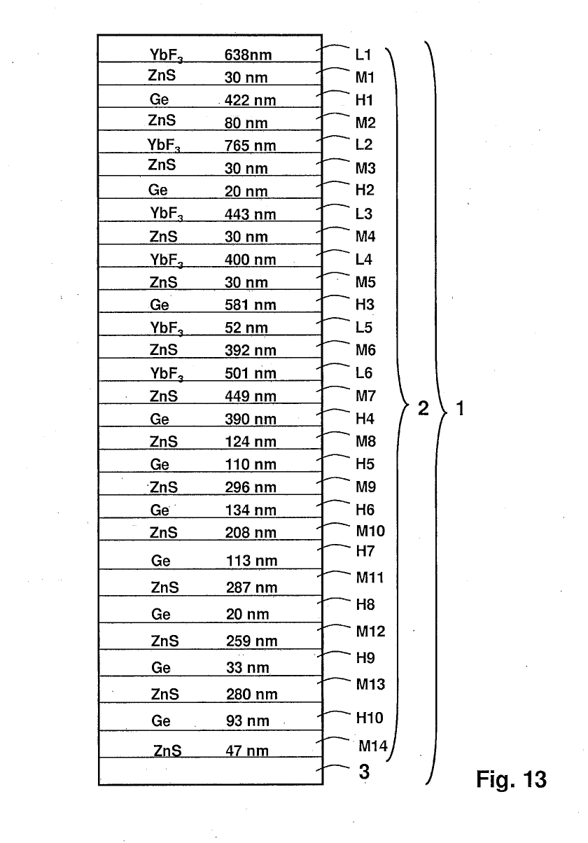

In a seventh embodiment of the optical component 1 according to the invention shown in FIG. 13, there is stacked on a substrate 3, ZnS (zinc sulfide) in the present instance, a stack 2 of thirty layers, of which six layers are low-index layers L1 to L6, are made of YbF₃ (yttrium fluoride) and have individual layer thicknesses of 638 nm, 765 nm, 443 nm, 400 nm, 52 nm and 501 nm; fourteen layers are mid-index layers M1 to M14, are made of ZnS (zinc sulfide) and have individual layer thicknesses of 30 nm, 80 nm, 30 nm, 30 nm, 30 nm, 392 nm, 449 nm, 124 nm, 296 nm, 208 nm, 287 nm, 259 nm, 280 nm and 47 nm; ten layers are high-index layers H1 to H10, are made of Ge (germanium) and have individual layer thicknesses of 422 nm, 20 nm, 581 nm, 390 nm, 110 nm, 134 nm, 113 nm, 20 nm, 33 nm and 93 nm. A mid-index layer M4 is provided between layers L3 and L4. The sequence of layers of the stack 2 over the substrate 3 is shown in FIG. 13. The mid-index layers M1 to M14 have compressive strains, the low-index layers L1 to L6 and the high-index layers H1 to H10 have tensile strains.

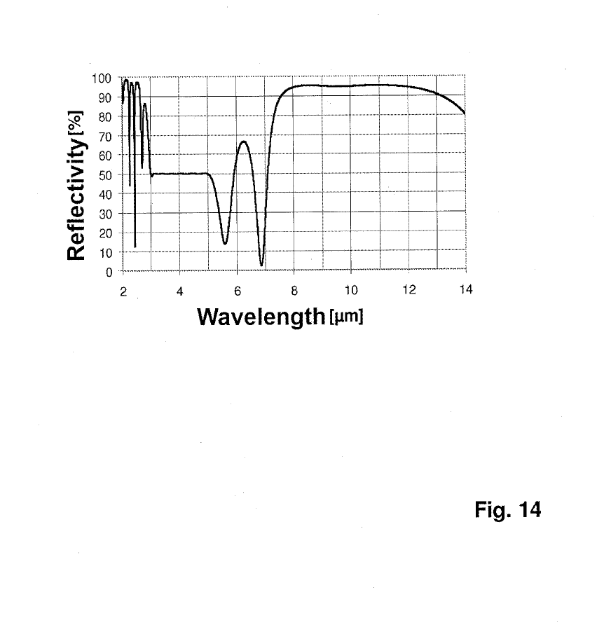

As is shown schematically in FIG. 14, the optical component 1 according to the seventh embodiment has a reflectivity of a targeted 50% in a wavelength range of a first atmospheric window from about 3.1 to 5 μm and a reflectivity of at least 90% over the wavelength range of the second atmospheric window from about 7.6 to 13 μm. The highest values of reflectivity are achieved approximately in the wavelength ranges from 8 to 11.5 μm.

The basic outline of the method according to the invention for designing an optical component 1 for the IR range is described with reference to the first embodiment example according to FIG. 1.

First, the desired technical characteristics of the optical component 1 to be designed are determined. The optical component 1 should have reflectivities of at least 90%, respectively, over a portion in the wavelength range from 3.7 to 4.3 mm of the first atmospheric window and over a portion in the wavelength range from 7.5 to 10 μm of the second atmospheric window. No reflectivity is specified between the above-mentioned portions. Further, strains occurring in the optical component are to be minimized and a small total layer thickness is to be obtained. Accordingly, a dual-band reflector with the above-mentioned technical characteristics is to be designed. YbF₃ is to be used as material for the low-index layers and Ge is to be used as material for the high-index layers. Both have tensile strains (negative strain coefficients).

The desired technical characteristics are entered into a simulation software as input data and a simulation is carried out. A simulated optical component having a layer sequence of a high-index layer H1 (layer thickness: 698 nm), a low-index layer L1+L2 (702 nm) and a further high-index layer H2+H3 (1190 nm) is obtained as result in a virtual manner. The low-index layer L1+L2 is then divided into two partial layers L1 and L2, and a mid-index layer M2 is inserted as “compensating layer”. The high-index layer H2+H3 is also divided and a mid-index layer M3 is inserted. To promote adhesion between the high-index layer H1 and the low-index (partial) layer L1, a mid-index layer M1 is inserted. All of the mid-index layers are made of ZnS and have compressive strains (positive strain coefficient). The simulated optical component modified in this way is simulated again in a further simulation taking into account all of the modifications carried out. In so doing, the layer thicknesses of the modified simulated optical component are adapted in such a way that their sequence remains unchanged, but the individual layer thicknesses of all of the layers are recalculated. An optical component 1 with the desired technical characteristics is obtained.

In a further embodiment example of the method according to the invention, only the individual layer thicknesses of the mid-index layers are adapted.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed is:

1. Method for designing an optical component for the IR range comprising the following steps:
a) determining desired technical characteristics of the optical component,
b) simulating an optical component having the desired technical characteristics, wherein the simulated optical component has a layer sequence of layers which are stacked one upon the other and have at least one low-index layer whose refractive index lies in a range from 1.35 to 1.7 and a high-index layer whose refractive index lies in a range from 3 to 5,
c) generating a modified simulated optical component by dividing at least one low-index layer of the simulated optical component into at least two partial layers and by inserting a mid-index layer between at least two of the partial layers, wherein the refractive index of the mid-index layer lies in a range from 1.8 to 2.5 and its strain coefficient has an opposite sign with respect to the strain coefficient of every low-index layer and every high-index layer,
d) adapting the layer thicknesses of the modified simulated optical component by means of a further simulation such that the modified simulated optical component has the desired technical characteristics, and
e) providing the results of the further simulation such that information about the layer sequence and specification of the thicknesses of the layers of the layer sequence are accessible to a user.

2. Method according to claim 1, characterized in that in step c) at least one high-index layer of the simulated optical component is additionally divided into at least two partial layers and a mid-index layer is inserted between at least two of the partial layers.

3. Use of a method according to claim 1 in a process for producing an optical component.

4. Optical component for the IR range comprising a substrate and a stack of optical layers with individual layer thickness which are stacked one upon the other on the substrate, wherein
the stack has at least one low-index layer whose refractive index lies in a range from 1.35 to 1.7 and a high-index layer whose refractive index lies in a range from 3 to 5,
that at least one low-index layer is divided into at least two partial layers, and there is present between at least two of the partial layers a mid-index layer whose refractive index lies in a range from 1.8 to 2.5 and whose strain coefficient has an opposite sign with respect to the strain coefficient of every low-index layer and of every high-index layer,
a sequence of layers of the stack is selected in such a way that the reflectivity of the coating has selected, mutually independent values in a range from 50 to 100% reflectivity in a wavelength range from 0.8 to 16 μm over at least two portions of this wavelength range.

5. Optical component according to claim 4, wherein a predetermined reflectivity of the optical component can be realized through the selection of the layer thickness of at least one mid-index layer.

6. Optical component according to claim 5, wherein the strain coefficients of the mid-index layers are positive.

7. Optical component according to claim 4, wherein a material of the low-index layers is selected separately for each of the low-index layers from a group comprising YbF₃, BaF₂, MgF₂ and CaF₂.

8. Optical component according to claim 7, wherein the material of the mid-index layers is selected separately for each of the mid-index layers from a group comprising of ZnS, ZnSe, SiO and chalcogenide.

9. Optical component according to claim 8, wherein the material of the high-index layers is selected separately for each of the high-index layers from a group comprising Ge, Si, PbTe and CdTe.

10. Optical component according to claim 9, wherein the material of the substrate is selected from a group comprising Ge, Si, chalcogenide glasses, sapphire, ZnS, ZnSe, quartz, fused silica, CaF₂ and MgF₂.

11. Optical component according to claim 4, wherein the optical component is a MEMS component.

12. Use of an optical component according to claim 4 as narrow-band filter.

13. Use of an optical component according to claim 4 as single-band reflector, dual-band or multi-band reflector.
